(19) United States
(12) Patent Application Publication
(10) Pub. No.: US 2023/0350398 A1
(43) Pub. Date: Nov. 2, 2023

(54) NATURAL INPUT PROCESSING FOR MACHINE DIAGNOSTICS

(71) Applicant: DEERE & COMPANY, Moline, IL (US)

(72) Inventors: Murtaza Hita, Pune (IN); Curtis P. Ritter, Waterloo, IA (US); Piyush Gupta, Pune (IN); Jason E. Brinkman, Cedar Falls, IA (US)

(21) Appl. No.: 17/733,241

(22) Filed: Apr. 29, 2022

(51) Int. Cl. G05B 23/02

(52) U.S. Cl. CPC G05B 23/0216

(57) ABSTRACT

An industrial machine diagnostic system includes a communication interface in communication with a database storing diagnostic information related to one or more industrial machines, a database storing user profile information, and a user device configured to transmit a diagnostic request for a machine. A data analysis and recommendation component is in communication with the communication interface and includes one or more processors and a non-transitory computer-readable medium containing instructions. The instructions instruct the processor to process the request to extract one or more request data elements, extract one or more diagnostic data elements, extract one or more profile data elements, determine a diagnostic recommendation based on analysis of the one or more request data elements, the one or more diagnostic data elements, and the one or more profile data elements, and output one or more diagnostic recommendations to the user.

### FIELD

Various exemplary embodiments relate to natural input (e.g., language text, image, voice, etc.) processing for industrial machine system diagnostic.

### BACKGROUND

Interactions between computers and humans has been a challenge that persists even today. Most of the times, humans are required to learn specific ways to interact with computers, say for example learn a particular computer language or train on a specific software tool. This creates a blocking pre-requisite before a useful human-computer interaction can take place.

The changing nature of software systems and learning curve involved can come into play when diagnosing problems with modern industrial machines, which can include industrial vehicles (e.g., agricultural, construction, forestry, mining vehicles, etc.) and stationary industrial equipment (e.g. generators, pumps, compressors, etc.). These machines are complex systems that can include numerous Electronic Control Modules (ECMs) and/or units (ECUs). Due to this complexity, diagnosing failures in communication systems (i.e. Controller Area Networks (CAN), Local Interconnect Network (LIN), Ethernet, etc.) is becoming more difficult. Certain industrial machines are equipped with internal diagnostic systems. Internal systems however, may be limited in scope due to size, cost, or performance considerations. Technicians and service centers are often equipped with significantly more robust and sophisticated diagnostic capabilities, but still lack the ability to efficiently diagnose and correct all issues.

### SUMMARY

According to certain aspects an industrial machine diagnostic system includes a communication interface in communication with a first database storing diagnostic information related to one or more industrial machines, a second database storing user profile information, and a user device configured to transmit a natural input diagnostic request for a machine and receive an output from the communication interface. A data analysis and recommendation component is in communication with the communication interface and includes one or more processors and a non-transitory computer-readable medium containing instructions. The instructions instruct the processor to process the natural input diagnostic request to extract one or more request data elements, process diagnostic information received from the first database to extract one or more diagnostic data elements, process user profile information from the second database to extract one or more profile data elements, determine a diagnostic recommendation based on analysis of the one or more request data elements, the one or more diagnostic data elements, and the one or more profile data elements, and output one or more diagnostic recommendations to the user.

In certain configurations the user data includes an information format preference and the data analysis and recommendation component outputs diagnostic information in a format based on the format preference.

In certain configurations a data search engine is configured to automatically retrieve information from one or more databases.

In certain configurations the communication interface is configured to receive feedback information based on the one or more diagnostic recommendations and provide the feedback information to a feedback engine in communication with the data analysis and recommendation component.

In certain configurations a background diagnostic component is configured to identify one or more diagnostic issues that can be resolved without user engagement and provide instructions to the machine to perform one or more actions to automatically resolve the one or more identified diagnostic issues.

In certain configurations the instructions include a command to download a software update.

In certain configurations a natural language processing component is configured to identify asynchronous conversations and perform topic structure identification and information extraction to match relevant conversation data to the diagnostic request data.

In certain configurations the data analysis and recommendation component is configured to receive a video input from a user, perform image recognition on the video input to obtain video data, and determine the diagnostic recommendation based on analysis of the video data.

In certain configurations the data analysis and recommendation component is configured to receive an audio input from a user, perform audio recognition on the audio input to obtain audio data, and determine the diagnostic recommendation based on analysis of the audio data.

In certain configurations the user profile data includes data related to past diagnostics performed by the user.

Certain aspects are directed to a method of resolving a machine diagnostic request. A natural input diagnostic request is received through a communication interface. The natural input diagnostic request is processed with one or more processors to extract one or more request data elements. Diagnostic information is received from one or more databases. The diagnostic information is processed to extract one or more diagnostic data elements. User profile information is received from one or more databases. The user profile information is processed to extract one or more profile data elements. A diagnostic recommendation is determined based on an analysis of the request data elements, the diagnostic data elements, and the user profile data elements. The diagnostic recommendation is provided to the user through the communication interface.

In certain aspects the natural input diagnostic request includes audio data, video data, or text data.

In certain aspects one or more diagnostic issues are identified that can be resolved without user engagement and instructions are provided to the machine to perform one or more actions to automatically resolve the one or more identified diagnostic issues.

In certain aspects the instructions include a command to download a software update.

In certain aspects an asynchronous conversation is received and topic structure identification and information extraction is performed to match relevant conversation data to the diagnostic request data.

In certain aspects an industrial machine diagnostic system includes a natural input processing engine. A software database is in communication with the natural input processing engine. A machine fleet database is in communication with the natural input processing engine. A diagnostic database is in communication with the natural input processing engine. A user profile database is in communication with the natural input processing engine. A user device is in communication with the natural input processing engine. The natural input processing engine is configured to, process a natural input diagnostic request from the user device to extract one or more request data elements, process information received from the software database, machine fleet database, diagnostic database, and user profile database to extract one or more diagnostic data elements and one or more user profile data elements, determine a diagnostic recommendation based on analysis of the one or more request data elements, the one or more diagnostic data elements, and the one or more profile data elements, and output one or more diagnostic recommendations to the user.

In certain aspects the natural input diagnostic request includes audio data, video data, or text data.

In certain aspects the natural input processing engine includes a data search engine, a communication interface, a feedback engine, and a data analysis and recommendation component.

In certain aspects the natural input processing engine is configured to identify one or more diagnostic issues that can be resolved without user engagement and provide instructions to the machine to perform one or more actions to automatically resolve the one or more identified diagnostic issues.

In certain aspects the natural input processing engine includes a natural language processing component configured to identify asynchronous conversations and perform topic structure identification and information extraction to match relevant conversation data to the diagnostic request data.

### BRIEF DESCRIPTION OF THE DRAWINGS

The aspects and features of various exemplary embodiments will be more apparent from the description of those exemplary embodiments taken with reference to the accompanying drawings.

FIG. 1 is a schematic view showing a technician and diagnostic options.

FIG. 2 is a schematic of an exemplary Natural Input Processing Engine used in a diagnostic system.

FIG. 3 is a schematic of a Natural Input Processing Engine component.

FIG. 4 is a flow chart of an exemplary natural input recommendation process.

FIG. 5 is a flow chart of a diagnostic system and recommendation process using the Natural Input Processing Engine.

FIG. 6 is a continuation of the flow chart of FIG. 5.

FIG. 7 is a schematic of a natural language processing component.

FIG. 8 is a flowchart of a diagnostic request utilizing the natural language processing component.

FIG. 9A is a flow chart of a diagnostic request utilizing the natural language processing component.

FIG. 9B is a continuation of FIG. 9A.

FIG. 10 is a flow chart of the Natural Input Processing Engine providing diagnostics using audio and video inputs.

FIG. 11A is a flow chart of a background diagnostic procedure.

FIG. 11B is a continuation of FIG. 11A.

FIG. 12 is a schematic of a user profile component.

### DETAILED DESCRIPTION OF EXEMPLARY EMBODIMENTS

Diagnosing engine and vehicle or machine faults and problems can be time-consuming and challenging for technicians due to complexity of engine control and emissions systems and vehicle or machine communication networks, or interactions between components and systems such as engine, transmission, hydraulics, electronics, etc. Searching for the applicable training needed to solve the problem, or the format or delivery of solutions that the technician prefers, can add to the time it takes to resolve an issue. Certain tools have been developed to enhance this process, including those described in U.S. Pat. Application No. 15/792,474; U.S. Pat. Application No. 17/580,351; U.S. Pat. No. 11,233,713; and U.S. Pat. Application No. 17/207,127, the disclosures of which are hereby incorporated by reference in their entirety.

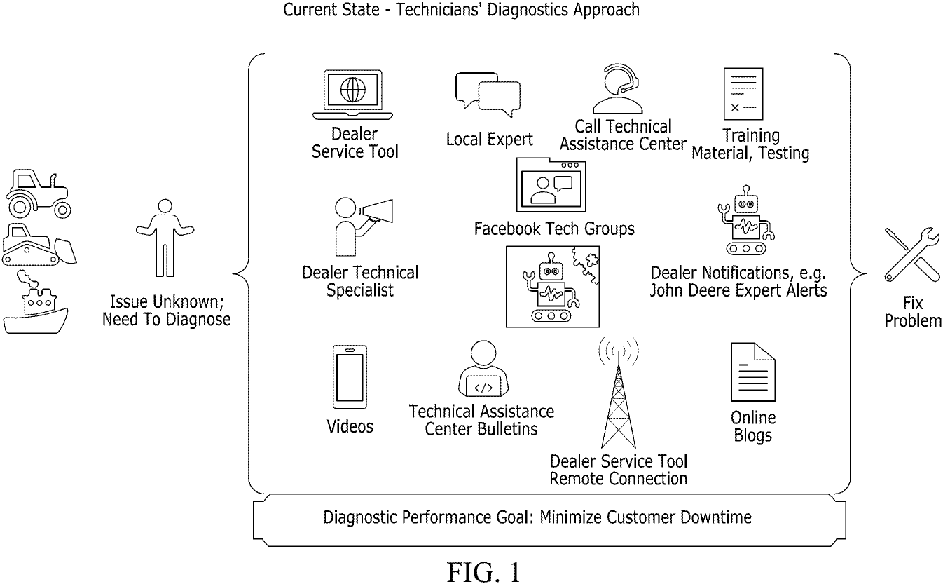

As depicted in FIG. 1, users (e.g. technicians, dealers, etc.) may need to review multiple sources of information to determine what parts or tools and equipment are needed to diagnose and repair a machine. These sources of information are located in different places, have different levels of accuracy, and can require different access credentials. Technicians may also be restricted on work they are authorized to perform based on experience, training, or other factors, either at the Dealership or from the manufacturer. This can lead to time and labor intensive efforts to correctly diagnose a machine problem, resulting in increased expense and machine downtime.

Modern day computational power and techniques can be utilized to create a Natural Input Processing Engine (NIPE) which can convert natural human inputs (e.g., written language, oral langue, audio inputs, video inputs) into a computer-meaningful data that can be further used for many human facing applications, like interactions with operators, technicians or any generic employee.

The system can be designed to receive input from a variety of sources and offer specific diagnostic and repair procedures tailored to the individual user. The system can be based on the types of questions the user has asked, their history with tools and systems, training they have taken, access and authority they have and more. The system can also include input on the type of machine they are diagnosing and repairing, and give recommendations for the user based on the machine’s faults, usage data, history, available updates, tools and parts needed for this repair, additional training the user might need, etc. The system can also include logistic recommendations for the user such as priority of machines to repair (scheduling), route guidance to visit a machine at a customer location, customer specific information such as safety or security procedures, etc.

There are many potential data sources and types of questions a user could ask, but one example is with controller reprogramming events. The initial training data set is for controller reprogramming events from a large population of machines in the database. Training records are used to make recommendations on courses the user could take. The system distinguishes successful events vs. failed, and also analyzes the type of failure to make the appropriate recommendation. The system analyzes data real-time to provide recommendations immediately for the Technical Assistance Center and Dealer.

Additional embodiments include questions surrounding error codes, machine data, and so on. Technical Assistance Center cases are analyzed for success and to determine who a new case should go to, as well as determining when inaccurate advice is given and to suggest training or a better solution. The system can also be available to the user as a chatbot or voice interface. It is device agnostic, working on a web page, cellphone app, in a case management system or the dealer service tool, etc.

Successful and failed reprogramming records and controller software data from within the error logs such as instruction code mismatch, component calibration strings, corrupt files (e.g. bin) or data, adapter string errors (Baud rate, Vehicle Communication Interface VCI version, CAN Channel), etc. that are necessary to help resolve controller reprogramming issues.

Specific features can be added as content for more question types are added. These additional embodiments include social content data on the specific user such as: what training have they from the dealer or manufacturer, do they use technician Facebook groups, how do they typically view content (read the manual, watch training or YouTube videos), do they use Google Maps, etc.

Primary data sources can include: manufacturer database including controller programming and error files; servers for other tool return files and logs; Technical Assistance Center or Case management system and Warranty; Dealer Service tool; parts system; manufacturer training system and database; telematics system machine and vehicle data; dealer business system data; product engineering and verification and validation application data; online technician groups; Google maps, weather, etc.

Monitoring for the system can use targeted feedback from within the system. Time study and resolution info is determined from the manufacturer’s database including return files and logs for reprogramming issues. Targeted solution data and Technical Assistance Center or Case management system and Warranty data are monitored for time to resolution based on the questions asked in the system.

Additional embodiments of sources of where questions come from include: scraping or using an API from social media sites, for example from technician groups; video conference/meeting recordings, e.g. where demos are given to Dealer groups, or when a user is on a call with support personnel; the system listens or gets information from transcripts from the meetings; ability to pull context from videos, e.g. online video sites for questions to answer or for recommendations; and users allow system to listen and it could interject with a recommendation.

Machine vision and some image recognition analysis can be used to identify something and use that to help make recommendations. Some issues that can be resolved in real time include: what is the part number of this part (item identification); what parts distribution center or dealership has inventory of a certain part; how do I install this part; is the wear on this part out of spec; or is this piece in the right place or orientation (classification); the system analyzes an image and determines a part looks damaged, can check inventory / order a new one and give installation instructions; Optical Character Recognition (OCR) in case someone hand wrote questions and doesn’t want to type them in the system; pattern recognition; welding inspection; barcode or QR code recognition.

The system can also include sound analysis, and the model can be trained to recognize, interpret, and diagnose sounds. For example, engine sounds like misfire, piston slap, valvetrain issues, engine knock, etc. The system can include the ability to attach sound files or pull from videos with sound, so the user could ask “is this engine running properly” or “does this engine have excessive valvetrain noise”, etc.

Additional embodiments for vision and sound inputs include use of smart cameras and sound analysis hardware to enhance personalized suggestions. These devices can look and get inputs from surroundings, can see key/stalk positions, etc. in vehicle, read the display, etc. and identify the technician by face.

Advantages of the NIPE include: increased customer uptime through reduced diagnostics and repair time; improved technician effectivity due to targeted training and solutions specific for this user; diagnostic reduction through better diagnostics specific to the individual user (technician); diagnostic case resolution time reduction due to technician being better prepared before submitting a case; reduced warranty costs due to reduced diagnostics and repair times; and training efficiency gains by targeting specific training by individual user needs.

An exemplary Natural Input Processing Engine (NIPE) system can be customized to deliver personalized suggestions based on different information inputs. The NIPE can utilize neural networks for machine learning that can use data captured from various resources (electronic or human) in specific environments. The NIPE could be provided as a service with help of easily accessible general functions over multiple access methods. The usage and data generated by the service can in turn aid in further refinement of the algorithm of the NIPE. The NIPE can cater to three different types of users at a very high level: internal users (factory operator on any other employee, etc.); intermediate users (trusted users but not internal, e.g., dealers, technicians, etc.); and external users (product end user, like a display unit on a machine).

The system and method inputs data from a variety of sources into a machine learning algorithm, and it offers specific diagnostic and repair procedures tailored to the individual user. It is based on the types of questions the user has asked, their history with tools and systems, training they have taken, access and authority they have and more. The system also includes input on the type of machine they are diagnosing and repairing, and give recommendations for the user based on the machine’s faults (error codes, DTCs, etc.), usage data, history, available updates, tools and parts needed for this repair, additional training the user might need, etc. The system could also include logistic recommendations for the user such as priority of machines to repair (scheduling), route guidance to visit a machine at a customer location, customer specific information such as safety or security procedures, etc.

Advantages of the NIPE include: increased customer uptime through reduced diagnostics and repair time; improved technician effectivity due to targeted training and solutions specific for this user; diagnostic reduction through better diagnostics specific to the individual user (technician); diagnostic case resolution time reduction due to technician being better prepared before submitting a case; reduced warranty costs due to reduced diagnostics and repair times; and training efficiency gains by targeting specific training by individual user needs.

The NIPE system can be implemented across a fleet of different machines. This can allow information about different machines to be cross-referenced to identify similar issues. Information can be categorized by one or more of error codes, component or parts, type or model of machine, location, type of user, etc.

The system can accept various text and speech inputs and be used to provide automatic diagnostic information and recommendations. The system can be connected to any combination of a question database, live library, automated chat, or can be used assisting with manual chat. The system can also be used to help provide a hands-free diagnostic assistance where a technician verbally diagnosing a problem as they examine a machine and receives feedback based on the voice diagnostic. This scenario can be combined with audio and video signal processing from the technician to augment the problem diagnostic. This can be especially advantageous when combined with an augmented reality system that can provide video display information to a user in addition to audio or text data.

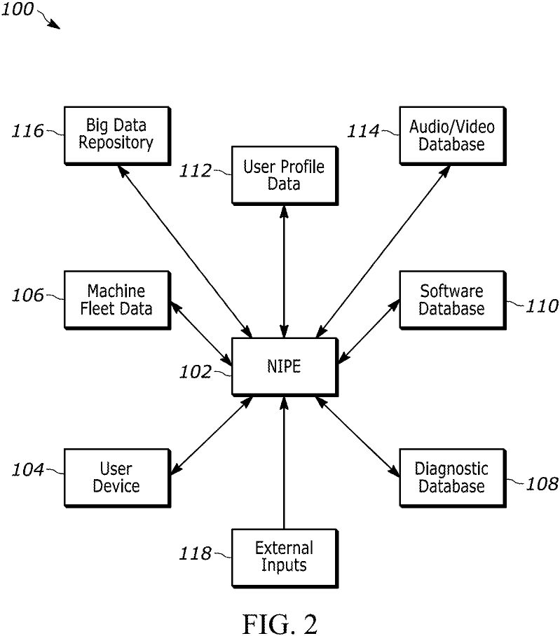

FIG. 2 depicts a diagnostic system 100 for one or more industrial machines that utilizes a NIPE 102. The NIPE 102 can be connected to a user device 104 that can include one or more devices such as a laptop, smartphone, diagnostic/service tool, in-vehicle compute system, etc. The NIPE 102 communicates with the user device 104 to receive and send a wide variety of data in different formats as described herein. The communication can be over a network through a wired or wireless communication.

The NIPE 102 is configured to connect with other systems to obtain, analyze and model data from a variety of sources. Examples of these as shown can include machine fleet data 106. The machine fleet data 106 can include information obtained from one or more industrial machines. These machines can be separated into groups based on machine design or operation type. For example, the machines can be grouped into agricultural or construction machines. The machines can be different types of machines, each being configured to perform a specific task (e.g., digging, harvesting, mowing, spraying, etc.). For example, the machines may include vehicles such as shovels, tractors, box drills, planters, harvesters, scrapers, sprayers, cutters, shredders, bailers, etc. The machines 104 can also or alternatively include other equipment that is not considered a vehicle.

Machine fleet data 106 can be obtained through service records as well as real-time data through a communication system. The communication system is configured to locally and remotely communicate information over a communication network. The communication system can provide communication over different wired or wireless systems and networks including mobile, satellite, Wi-Fi, near-field, Bluetooth, or a combination thereof as needed. In an exemplary embodiment, the communication system is a telematics system. The telematics system includes, for example, a network of regional, national, or global hardware and software components. In addition, the telematics service may be provided by a private enterprise, such as an independent third-party company that provides the service to other companies, a manufacturing company that provides the service to its customers, or a company that provides the service to its own fleet of vehicles. Alternatively, the telematics service may be provided by a governmental agency as a public service. JDLink™ is an example of a telematics service, which is available from John Deere & Company.

The NIPE 102 can also be connected to a diagnostic database 108. The diagnostic database 108 can include one or more servers that can contain historical diagnostic information. The diagnostic database 108 can be local or remote, and can store diagnostic information relevant to different machines. When technicians perform services on a machine, the technicians can record, on one of the networked computers, specific information about the service provided to the machine through a field technician computer system or through the machine itself. The technicians may record date of service, service issue resolved, manner in which the service issue was resolved, whether the service needs to be performed periodically as is the case with maintenance service, parts used to resolve the service issue, time necessary to resolve the service issue, steps taken before service issue was resolved (e.g., if other parts or components were checked before determining the root cause of a service issue), etc. In this context, this type of information regarding the service provided to the machine is referred to as field service data. Accordingly, when referring to field service data, reference is made to some or all of the information listed above as well as other information relevant to the service issue, the service provided, and the service result. The database may also include identifying information for the machine such as the type of machine, any serial and/or model numbers associated with the machine, a user associated with the machine (e.g., an owner or manager), and contact information for the user.

Once the diagnostic database 108 receives information relevant to a machine, the diagnostic system server stores the received information, for example on a non-transient computer-readable memory. The diagnostic database 108 executes instructions stored on the non-transient computer-readable memory that cause the diagnostic system server to access the machine-specific information stored on the memory and to develop an optimized list of steps for procedures to be performed by a technician using the service center computer system to resolve a particular service issue. In particular, the diagnostic database 108 is configured to access memory and identify, based on the stored data, a list of conditions relevant to the machine or conditions that will be relevant during a time of service. Based on the list of conditions relevant to the machine, the diagnostic database 108 can generate an ordered and optimized list of diagnostic procedures to be performed to address the identified service issue of the machine in an efficient manner. The ordered list takes into consideration the conditions identified as being relevant to the machine, the user information, the build data, the machine information, the location information, and relevant sensor information. In some embodiments, the diagnostic database 106 gives each of these pieces of information different weights in view of the conditions that are determined to be relevant to the machine. In certain aspects, the diagnostic database and the provided information can be referred to as a Diagnostic Technical Assistance Center (DTAC). A further explanation of an exemplary diagnostic procedure is described in U.S. Pat. 10,657,450, the disclosure of which is hereby incorporated by reference in its entirety.

The NIPE 102 can also be connected to a software database 110. The software database 110 can include a server with software information and file or driver updates. The software database 110 can be used to provide updates and other reprograming events to components on a vehicle such as a controller.

The NIPE 102 can also be connected to a user profile database 112. The user profile database 112 contains various data relating to the user accessing the NIPE 102. Examples of some of the user data can include: standard metadata such as user name, user ID, contact info, dealer contact info, field or shop technician, employment history, etc.; job history, work orders, warranty work performed, support tickets submitted; questions asked to the system, if they followed the recommendation, and the results; manufacturer and dealer training; preferred delivery method of content (read manuals, watch videos, step by step guidance, etc.); social media and Internet use they use for support and technical information; permissions or authorization - what are they authorized to work on (this can be based on dealer contracts but also training this person has had and machines they may be certified on or other factors); special certification, e.g. security clearance (e.g. military, power plant), safety clearance (e.g. chemical plants), etc.; competency, e.g. a score based on their problem resolution ability (the NIPE can then suggest additional training).

The NIPE 102 can also be connected to an audio/video database 114. The audio/video database 114 can include audio and video files related machine problems as well as to diagnostic solutions. For example, audio or video files submitted to the NIPE 102 can be cataloged along with problem solution data for later retrieval. In another example, audio and video files from training sessions and meetings can be stored and later analyzed to find problem and solution information. The audio/video database 114 can also include technical discussion threads.

The NIPE 102 can also be connected to a data repository 116. The data repository 116 can be a data lake structure that contains large amounts of data. In certain configurations, the data repository 116 can contain all of the other databases. The repository 116 can also include additional information associated with the machines, a company profile, additional user (e.g., technician, dealer) information, etc.

The NIPE 102 can also be connected to external inputs 118. The external inputs 118 can include any data housed in other locations, such as public information accessible through the Internet. This can include social media posts and threads, weather, maps, traffic information, inventory information, etc.

Each of the databases, user device, and NIPE can include one or more general purpose computers or servers capable of communicating over a network. Each can also include one or more processors, system memory, and a bus that couples various components through any standard architecture. The devices can also be provided with one or more disk drives (e.g., hard, magnetic, optical, etc.) to provide non-volatile storage for data of the computing devices. The devices can also have various input interfaces configured to provide remote or local access by a user.

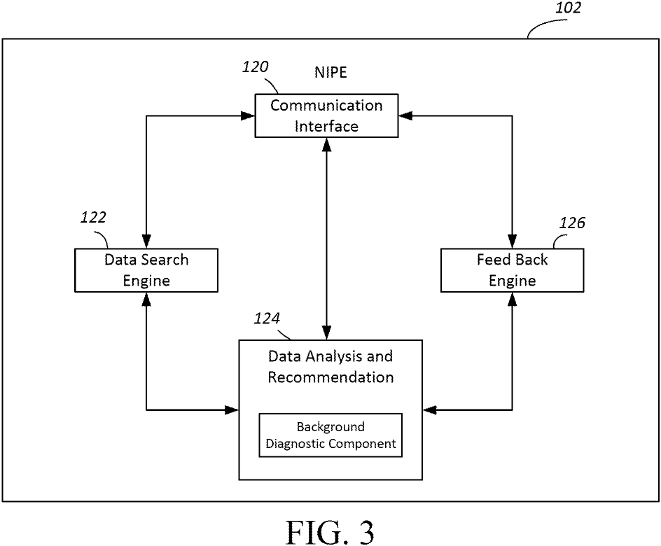

FIG. 3 shows an exemplary layout for the components of an NIPE 102. The NIPE 102 can include software and/or firmware stored in memory to perform different operations and tasks discussed herein. The NIPE can include one or more processors configured to execute instructions stored in local or remote memory, with the instructions designed to achieve the features discussed herein. The NIPE 102 includes a communication interface 120. The communication interface 120 can include one or more transceivers and be configured for any combination of wired or wireless communication. The NIPE 102 also includes a data search engine 122. The search engine 122 is configured to search and obtain data from any source external to the NIPE 102 (for example as shown in FIG. 2). The data search engine 122 can utilize one or more Robotic Process Automation (RPA) components to automate data acquisition to train and implement the NIPE 102. For example, one or more RPA components can be used to search technical alerts and instructional packages records to obtain relevant data. The search and retrieval can be done in real time to obtain information on recurring issues, best solutions to issues, etc. One or more RPA components can be used to search a central database for records in real time to identify errors present in return files, identifications of multiple programming events, etc.

After the information is collected by the RPA components, the data can be sent to a data analysis and recommendation component 124. The data analysis component 124 also receives a user input (e.g., voice, text, video) through the communication interface 120 identifying a problem or asking a question.

The data analysis component 124 can process the obtained data and the user diagnostic request to process the natural language, audio, and video components of the request and match it to a possible issue identification and one or more resolution recommendations. Accordingly, the data analysis and recommendation component 124 can include one or more components (e.g., programming instructions executed on one or more processors) that allow for speech recognition, natural language processing, audio identification, and machine vision combined with data analysis algorithms to process data and provide one or more relevant recommendations to diagnose an issue. These natural inputs are processed and converted to extracted data elements. The data analysis and recommendation component 124 can base the recommendation on the obtained diagnostic request as well as machine fleet data, user profile data, and other information obtained. The data analysis and recommendation component 124 also is configured to utilize machine learning techniques to improve future recommendations. Accordingly, a feedback engine 126 is provided that can obtain feedback on recommendations provided to a user. This feedback can include the success or failure of the recommendation, as well as any additional steps that were required to solve the issue.

If a solution is found it is output to the user through the communication interface 120. The output component can provide the recommendation via a technician service tool, a support system, an automated alert (e.g., John Deere Connected Support™ Expert Alert for an issue that is created based on the data collection and analysis and delivered to a Service Dealer or technician), manual delivery (e.g., phone, email, text message), etc. The solution can be any combination of audio, video, and text based and can be provided to a user based in part on that user’s preferences.

In addition, the data analysis component 124 is configured to identify the machine that is being diagnosed and obtain data directly from the machine which provides additional diagnostic information. This can be, for example, telematics data from the machine. This additional diagnostic information can be error codes as well as general operating information that is stored or processed by one or more on board controllers. This information can be used to diagnose a problem presented by a user and to also suggest additional maintenance work that should be done to the machine. In this way, the system can be running in the background of a request to provide additional support that was not known to the user or requested.

The data analysis and recommendation component 124 can also include a background diagnostic component that is configured to automatically provide a diagnostic solution to a machine. Automatically outputting a diagnostic solution to a machine can be triggered by a user diagnostic request or through an automated monitoring system. For example, a user can provide a diagnostic request based on an observed diagnostic issue. The NIPE 102 can identify the machine and pull any error logs from that machine through an online diagnostic database continuously connected to the machine (e.g., telematics). The NIPE 102 can determine any potential issues that could be resolved automatically, (e.g., software update, controller reprogramming, etc.), and provide instructions to the machine to take the necessary steps to resolve or begin to resolve the identified issues.

After a solution is output, the feedback component 126 can be used to analyze the effectiveness of the solution. The feedback component 126 can receive data including, effectiveness of solution, time to solve, additional test or steps needed etc. The system can be constantly running as a program component in a diagnostic system. The system can continuously learn to improve, utilizing machine learning algorithms to refine solutions to problems.

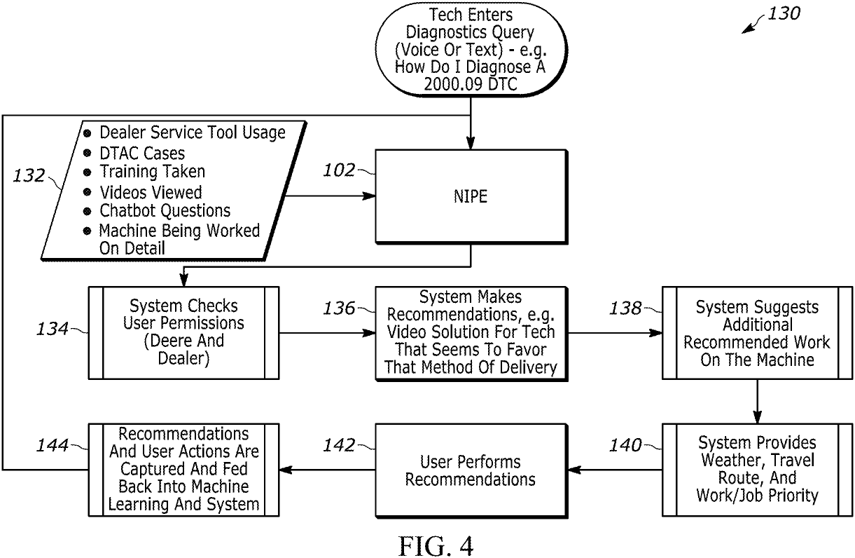

FIG. 4 shows an exemplary scenario 130 of a user utilizing the NIPE 102. A user can provide a diagnostic request 130 that is input to the NIPE 102. The diagnostic request 130 includes a request to solve a specific diagnostic trouble code (DTC). DTCs are described and used herein, and it should be understood that the system can use any type of operational data or operational codes, which includes any error codes, non-error operating codes, DTCs, and other information. The NIPE 102 is connected to data sources 132 that provides service information, diagnostic information, training information, video data, chat question data, and machine data. This information is processed with the request and the system can check the user’s permissions 134 and makes a recommendation for the problem request 136. The system can then suggest additional recommended work on the machine 138 based on obtained machine data.

The system can then provide logistical information 140 to the user, providing weather information, travel route, job priority, part availability, and other logistical information as needed. The user then performs the recommendations 142. The user’s actions can be captured and returned to the system as feedback 144.

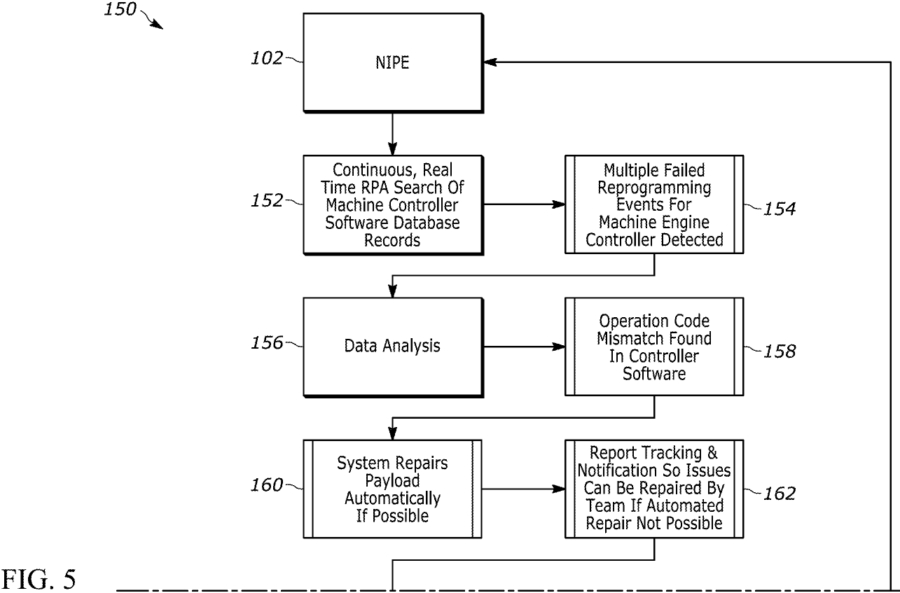

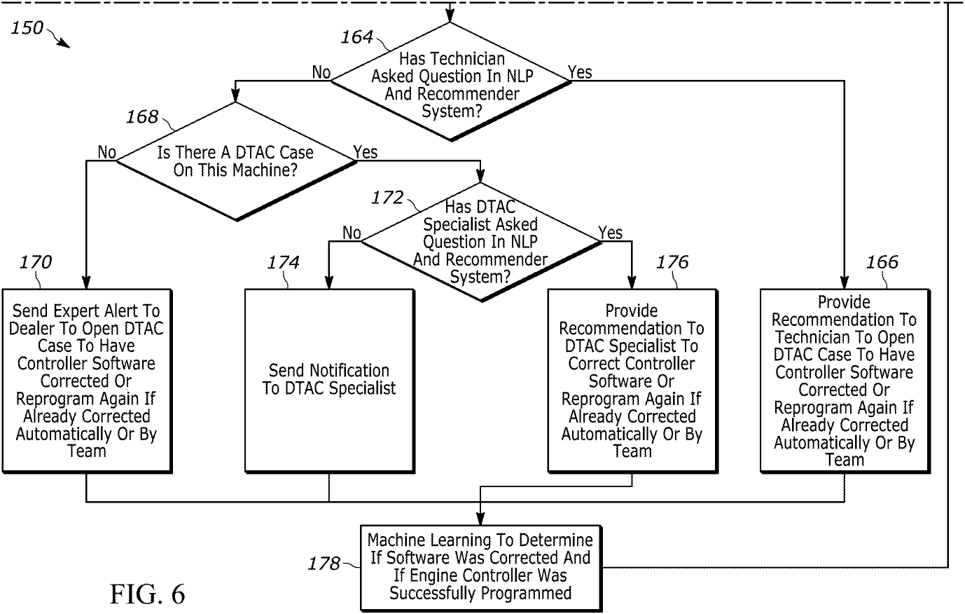

FIGS. 5 and 6 show another exemplary scenario 150 of a user utilizing the NIPE 102. In certain configurations the NIPE 102 can be working continuously to perform real time searching of a diagnostic database to collect diagnostic records 152. In the illustrated example the NIPE 102 recognizes multiple failed reprogramming events for a machine engine controller 154. A data analysis 156 is performed on the failed reprogramming events to determine a possible solution. For example, it can be determined that an operation code mismatch is present in the controller software 158. The system then determines if the software payload can be repaired automatically 160 and repairs the payload if possible. If it is not possible, a report can be created 162 so issues can be repaired by a user.

The system monitors whether a user has asked a question or submitted a diagnostic request using a natural input 164. If so, a recommendation is provided to the user 166 to open a DTAC case to have the controller software corrected or reprogrammed again. If no question has been asked, it is determined if there is a DTAC case tied to the specific machine 168. If there is no DTAC case, then an automated alert 170 can be sent to a dealer to open a DTAC case to have the controller software corrected or reprogrammed again. If there is a DTAC case on the machine it is determined if the DTAC specialist has asked a question to the NIPE 172. If not, a notification is sent to the DTAC specialist 174. If a question has been asked, then a recommendation is provided to the DTAC specialist to correct the controller software or reprogram the controller again 176. The information for the process is compiled and fed back to the NIPE 102 and machine learning is used to determine if the issue was corrected 178.

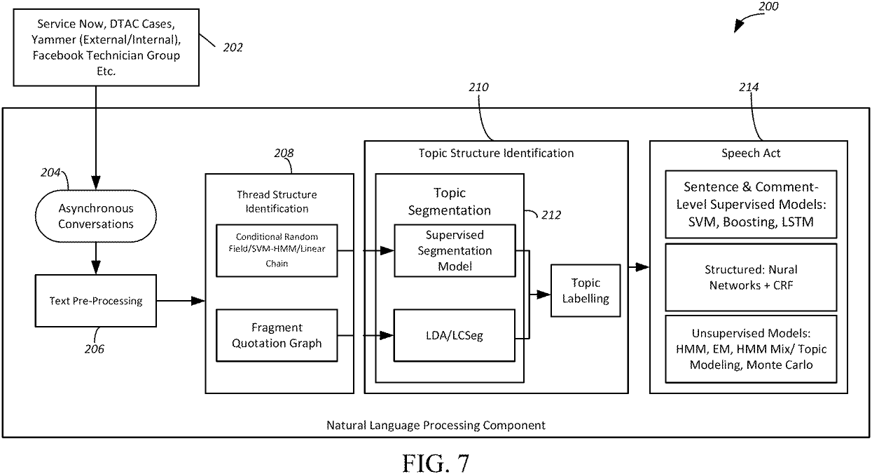

FIG. 7 shows an exemplary schematic for a natural language processing component (NLPC) 200 that can be used with the NIPE 102. The NLPC 200 can be part of the data analysis and recommendation component 124 as shown in FIG. 4 or a separate component. The NLPC 200 includes data input 202 from a variety of sources as discussed herein. The NLPC 200 can identify asynchronous conversations 204 and perform text pre-processing 206. The text pre-processing 206 can include spelling correction, translation (if there are multiple data sources in different languages for similar products or issue), lower casing everything, removing punctuations and special characters etc. The preprocessing can also include converting audio into text based on one or more speech recognition algorithms (e.g., neural networks, End-to-end models, etc.). After text pre-processing 206, thread structure identification 208 is performed. Thread structure identification 208 can disentangle in case of multiple concurrent conversations or discover direct & indirect replies within a conversation. This can be achieved by using Hidden Markov models, Conditional Random Forest/Field, Support Vector machines (SVM) sequence tagging, or Fragmented Quotation Graph techniques. Topic structure identification 210 is also performed to discover topics within a piece of voice/text or complete thread. Topics can be labelled to assign a logical label which may reflect the high-level purpose. The topic structure identification can include topic segmentation 212 which uses supervised learnings methods (e.g. supervised segmentation model) or lexical chain-based methods (e.g., Latent Dirichlet Allocation, LCSeg). The data can also be processed for speech act recognition 214. This includes processing data to understand and detect a speaker’s intentions in using certain dialogue (text or speech). These can include identification and classification of questions, statements, or commands. The speech act recognition 216 can include using sentence and comment supervised models (e.g. SVM, Boosting, LSTM), structured models (e.g., neural networks and conditioned random field). These components are used to obtain, organize, and model data so that it can be matched to later user diagnostic requests and provide recommendations.

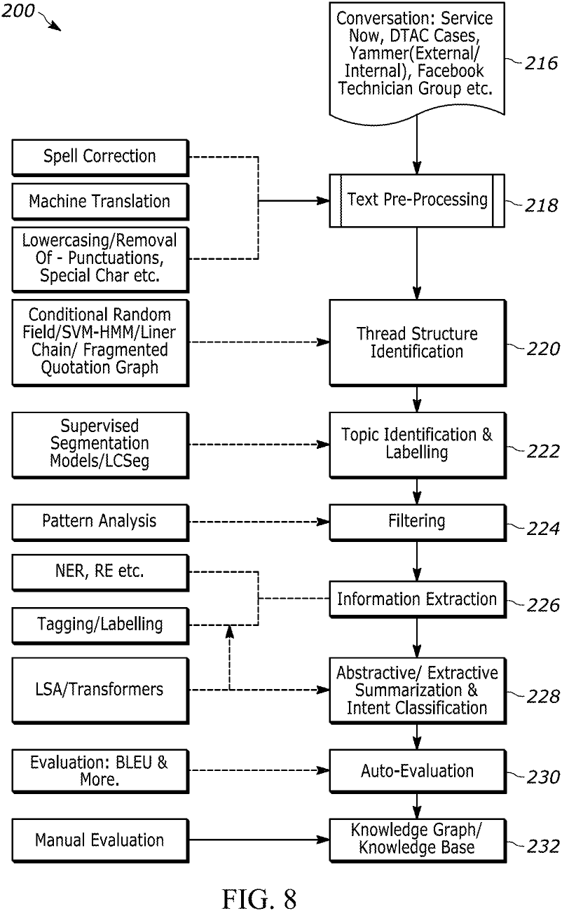

FIG. 8 shows an exemplary flow chart for the NLPC 200. Data (text or voice request) is input 216 from a variety of sources and passed to text preprocessing 218 for text and audio processing as described with respect to FIG. 7. The data undergoes thread structure identification 220 and topic identification and labeling 222 as described with respect to FIG. 7. The data can then be filtered 224 to segregate relevant pieces of information from the given conversations and eliminate the text which is not relevant in general. This can be achieved by pattern recognition or learning based techniques. The data then undergoes information extraction 226 that extracts specific information in a structured format from the given raw text (e.g., Serial number), this can be achieved by pattern or learning based techniques like LSA/transformers etc. The data can also undergo abstractive/extractive summarization and intent classification 228. The summarization can shorten long pieces of text. Abstractive summarization produces a paraphrasing of the main contents of the given text, using a vocabulary set different from the original document and extractive summarization involves picking up the most important phrases and lines from the documents. Intent Classification is automated categorization of text data based on writer’s goals similar to speech act recognition discussed with respect to FIG. 7. Automatic evaluation 230 is performed to determine how often the words in the machine generated summaries appeared in the human reference summaries. The processed data can be stored in a knowledge graph and a knowledge base 232.

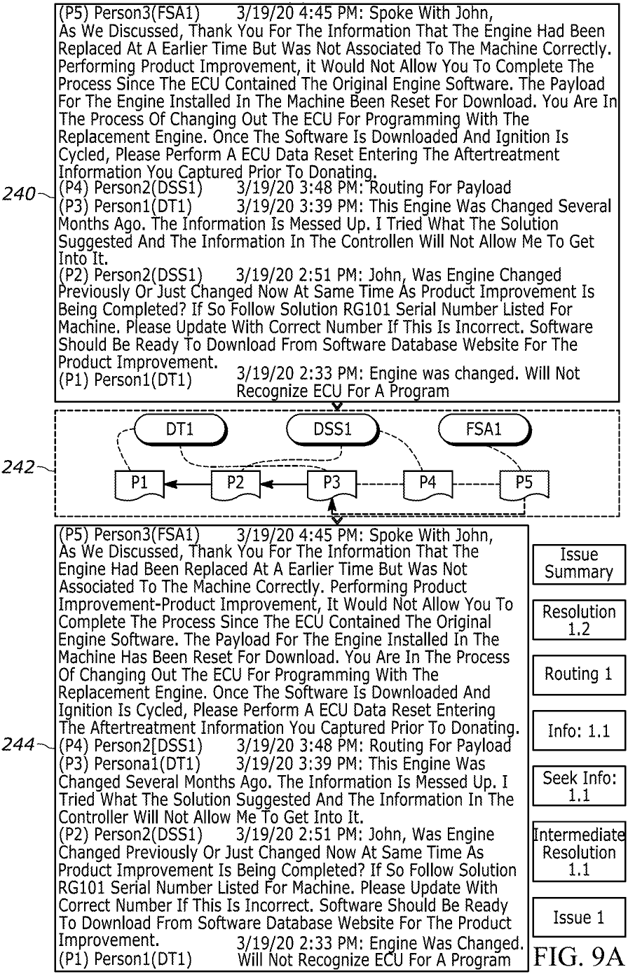

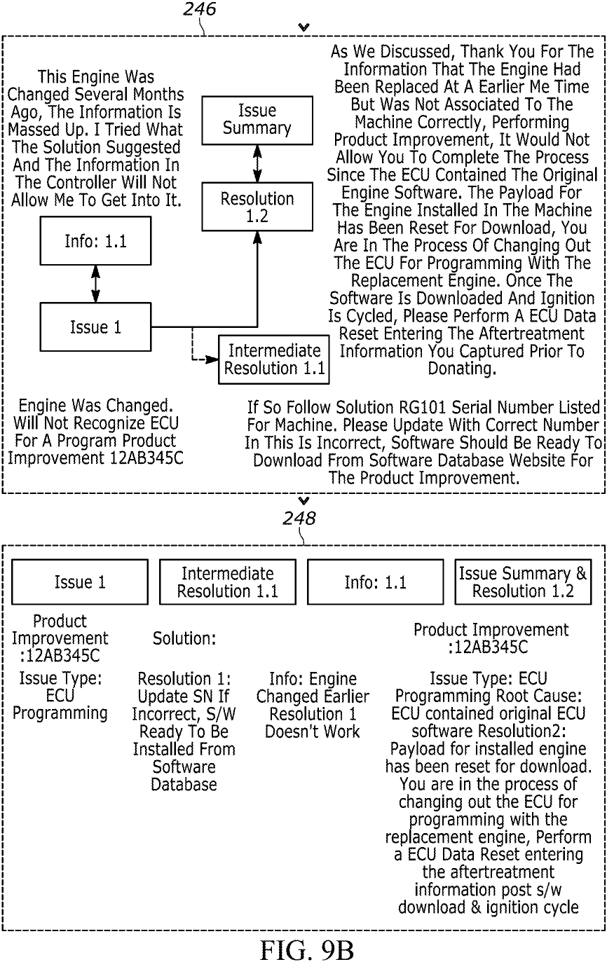

FIG. 9 shows an example of an asynchronous conversation 240 that can be processed by the NLPC 200. The conversation 240 includes a text exchange (P₁-P₅) between a dealer technician (DT), a factory support analyst (FSA), and a dealer support specialist (DSS). The text is input into the system and undergoes preprocessing. In box 242 thread structure identification is performed to tie the different statements to the proper user. In box 244 topic identification and labeling is performed to identify and label the different parts of the conversation. In box 246 the information is filtered. In box 248 the information is extracted, summarized, classified, and stored.

The NIPE 102 can then call any of this information to respond to a diagnostic request. For example, the NIPE 102 can receive a diagnostic request input and determine that the request is based on an ECU programming issue and provide the prior resolution information to the user.

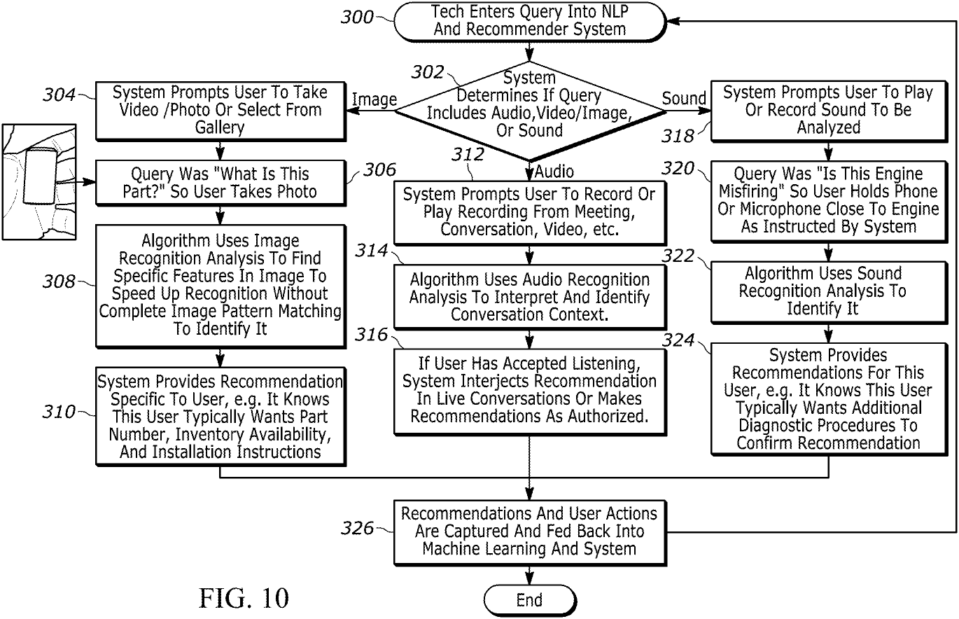

FIG. 10 shows a flowchart of the NIPE 102 performing diagnostic requests that utilize images, audio, or sound. A user can enter a diagnostic request 300 and the NIPE can determine if the request includes or requires one or more of a video/image input, an audio input, or a sound input 302. This determination can be made by analyzing the request alone or by receiving a separate input from the user. Each of these paths can be followed separately or in tandem with one another during a diagnostic procedure.

If a video or images are needed, the system prompts the user to take a video or photo or to upload a previously recorded image/video 304. The user can then provide an additional query 306 further defining the request. The NIPE 102 utilizes image recognition analysis 308 to identify specific features or pattern matching to components in the image or video. The NIPE 102 can then match the identified component to relevant diagnostic issues and solutions present in one or more databases. The system can then provide a diagnostic recommendation 310 based on the analyzed image and other features such as the machine data and user profile. The system can also identify part numbers, inventory availability, and installation instructions to the user.

If an audio file is needed, the system prompts the user to record or play a prior recording from a meeting, conversation, video, or to begin a recording while performing a diagnostic inspection 312. For example, the system can identify based on the user profile or through a user input that the user would like to perform a diagnostic of a machine utilizing a hands-free voice input. In another example, the system can be activated to listen in on a phone conversation or a meeting where a diagnostic issue is being discussed. In any scenario, the system can analyze the audio data using one or more audio recognition algorithms 314. Thy system can interject recommendations 316 into the live conversation or make recommendations on request or as otherwise authorized. These recommendations can be solutions to a problem and also requests for further information. In the hands-free diagnostic example, the system can prompt the user to disassemble or examine a specific part based on the input information.

If a sound input is required the system prompts the user to play or record the sound to be analyzed 318 and can receive an additional query from the user 320. The system utilizes one or more sound recognition algorithms to analyze and identify the sound 322 or a relevant sound pattern. The NIPE 102 can then match the identified sound to relevant diagnostic issues and solutions present in one or more databases. The system can then provide a diagnostic recommendation 324 based on the analyzed sound and other features such as the machine data and user profile. After all recommendations are provided the user actions are captured and fed back into the NIPE 326.

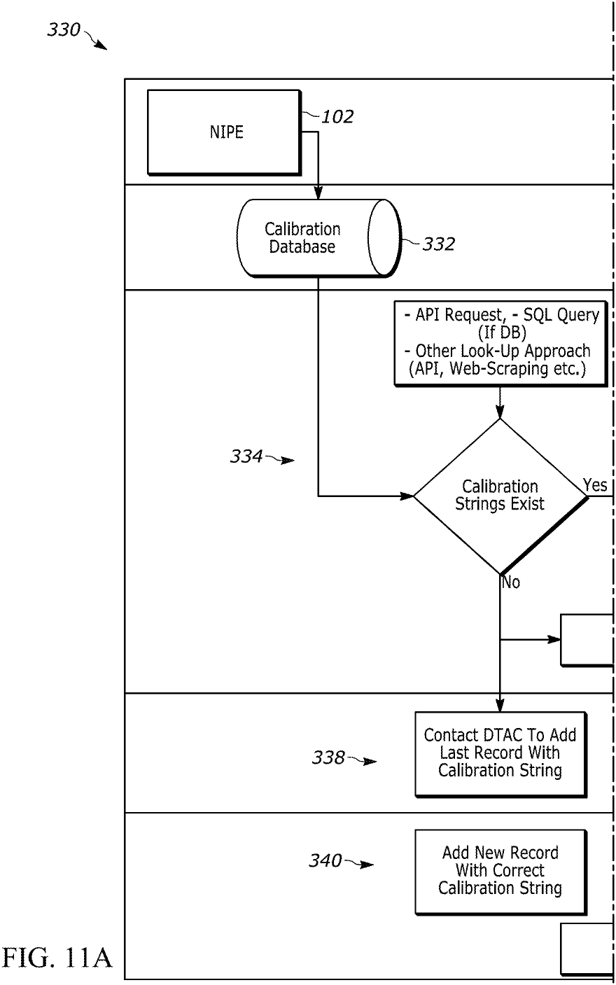

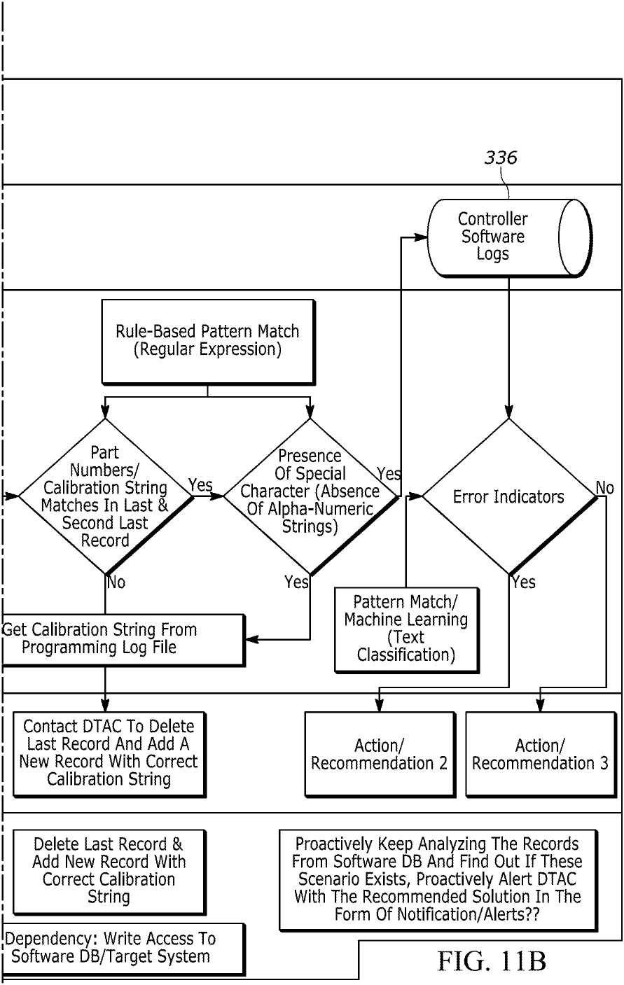

As discussed herein, the NIPE 102 can be configured to run in the background to collect data about a machine and provide diagnostic information to a user that is partially based on a user request or separate from a user request based on obtained information. FIG. 11 shows an exemplary flow chart of a background diagnostic procedure 330 addressing a controller programming issue. In the background diagnostic procedure 330, the NIPE 102 can pull information from a database 332, for example a diagnostic database that is in communication with a machine identified as being diagnosed by the user. This identification can be automatic, based on the user profile or other information, or can be manually input by the user. The database can access machine data to determine if a calibration string exists 334 and to obtain the proper calibration string from an error log database 336. Recommendations 338 can then be output to a user. These recommendations provide solutions based on information obtained directly from the machine which can be provided in addition to the information obtained from the user or to augment the information provided by the user.

In addition to the recommendations 338, the system can take action on its own to provide solutions as shown in block 340. These can be software updates, address corrections, or other software fixes that can be applied from the diagnostic database or software database directly to the machine without requiring actions from the user. In this way, the NIPE 102 can directly solve issues automatically based on the user’s diagnostic request or simply triggered by a user’s diagnostic request.

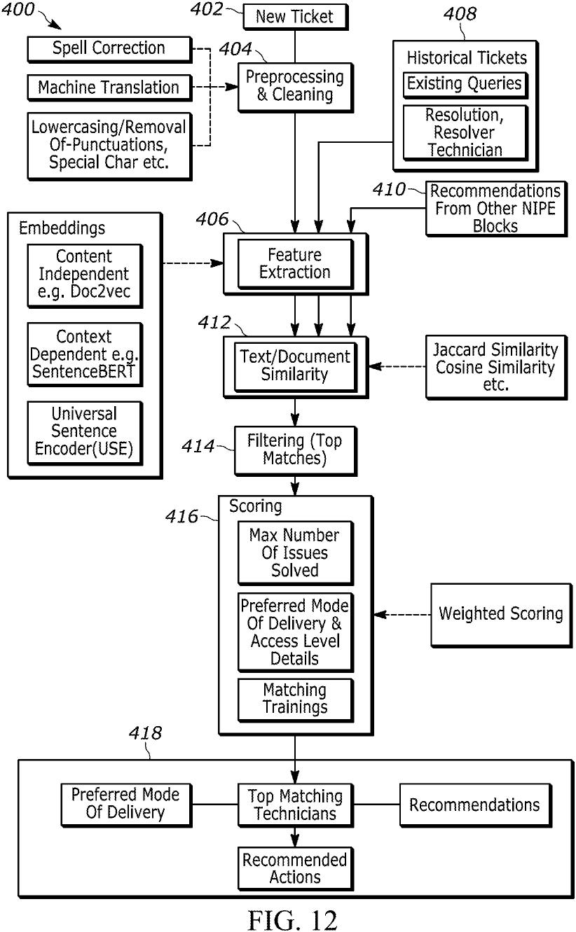

FIG. 12 shows an example of a user profile component 400 that is used by the NIPE 102 to create a customized recommendation. The user profile component 400 can be part of the data analysis and recommendation component 124 as shown in FIG. 3 or a separate component. A new diagnostic request ticket is received 402 by the user profile component 400 and text preprocessing 404 is performed. The processed diagnostic request is fed into a feature extraction component 406. Historical diagnostic request tickets 408 can also be received by the feature extraction component. The historical tickets 408 can include existing or open queries as well as information related to resolution of prior issues. The feature extraction component 406 also receives diagnostic recommendations from the NIPE 410.

The feature extraction component 406 can generate sentence embeddings, represent entire sentences and their semantic information as vectors. This can help the user profile component 400 in understanding the context, intention, and other nuances in the entire text. After feature extraction, the data is compared to the existing data and the data recommended by the NIPE to find similarities 412. For example, the data can be provided or compiled into one or more matrices and assigned different weights or values so that the information can be matched and a relevance score can be obtained. Next the system filers the top matches 414, for example identifying the highest score or scores representing information that is output to the user. The system can be configured to select the top score, a set number of top scores (e.g., top two or top three scores), it can select scores that meet a certain cutoff (e.g., above 50% match), or any combination thereof.

After the top matches are filtered, the user profile system can provide weighted scoring to the matches 416. The weighted scoring can take into consideration the users’ max number of issues solved, the preferred mode of delivery for the users, the access level for the users, and the matching training for the users. After the scores are weight adjusted, the recommendations can be output to one or more users. The recommendations can include the preferred method of delivery for the users, the top matching technicians for the recommendations (e.g., based on the known technicians for the machine, location, availability, etc.), the recommendations, and the recommended actions.

The foregoing detailed description of the certain exemplary embodiments has been provided for the purpose of explaining the general principles and practical application, thereby enabling others skilled in the art to understand the disclosure for various embodiments and with various modifications as are suited to the particular use contemplated. This description is not necessarily intended to be exhaustive or to limit the disclosure to the exemplary embodiments disclosed. Any of the embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

Terms of degree, such as “substantially” or “approximately” are understood by those of ordinary skill to refer to reasonable ranges outside of the given value, for example, general tolerances associated with manufacturing, assembly, and use of the described embodiments. Unless specified or limited otherwise, the terms “connected,” and “coupled” and variations thereof are used broadly and encompass both direct and indirect connections and couplings.

What is claimed is:

1. An industrial machine diagnostic system comprising:
a communication interface in communication with a first database storing diagnostic information related to one or more industrial machines, a second database storing user profile information, and a user device configured to transmit a natural language input diagnostic request for a machine and receive an output from the communication interface; and
a data analysis and recommendation component in communication with the communication interface and including one or more processors and a non-transitory computer-readable medium containing instructions to,
process the natural language input diagnostic request to extract one or more request data elements,
process diagnostic information received from the first database to extract one or more diagnostic data elements,
process user profile information from the second database to extract one or more profile data elements,
determine a diagnostic recommendation based on analysis of the one or more request data elements, the one or more diagnostic data elements, and the one or more profile data elements, and
output one or more diagnostic recommendations to the user.

2. The industrial machine diagnostic system of claim 1, wherein the user profile information includes an information format preference and the data analysis and recommendation component outputs diagnostic information in a format based on the format preference.

3. The industrial machine diagnostic system of claim 1, further comprising a data search engine configured to automatically retrieve information from one or more databases.

4. The industrial machine diagnostic system of claim 1, wherein the communication interface is configured to receive feedback information based on the one or more diagnostic recommendations.

5. The industrial machine diagnostic system of claim 1, further comprising a background diagnostic component configured to identify one or more diagnostic issues that can be resolved without user engagement and provide instructions to the machine to perform one or more actions to automatically resolve the one or more identified diagnostic issues.

6. The industrial machine diagnostic system of claim 5, wherein the instructions include a command to download a software update.

7. The industrial machine diagnostic system of claim 1, further comprising a natural language processing component configured to identify asynchronous conversations and perform topic structure identification and information extraction to match relevant conversation data to the diagnostic request data.

8. The industrial machine diagnostic system of claim 1, wherein the data analysis and recommendation component is configured to receive a video input from a user, perform image recognition on the video input to obtain video data, and determine the diagnostic recommendation based on analysis of the video data.

9. The industrial machine diagnostic system of claim 1, wherein the data analysis and recommendation component is configured to receive an audio input from a user, perform audio recognition on the audio input to obtain audio data, and determine the diagnostic recommendation based on analysis of the audio data.

10. The industrial machine diagnostic system of claim 1, wherein the user profile data includes data related to past diagnostics performed by the user.

11. A method of resolving a machine diagnostic request comprising:
receiving, through a communication interface, a natural language input diagnostic request;
processing, with one or more processors, the natural language input diagnostic request to extract one or more request data elements;
receiving, through the communication interface, diagnostic information from one or more databases;
processing, with the one or more processors, the diagnostic information to extract one or more diagnostic data elements;
receiving, through the communication interface, user profile information from one or more databases;
processing, with the one or more processors, the user profile information to extract one or more profile data elements;
determining, with the one or more processors, a diagnostic recommendation based on an analysis of the request data elements, the diagnostic data elements, and the user profile data elements; and
providing the diagnostic recommendation to the user through the communication interface.

12. The method of claim 11, wherein the natural language input diagnostic request includes audio data, video data, or text data.

13. The method of claim 11, further comprising identifying one or more diagnostic issues that can be resolved without user engagement and providing instructions to the machine to perform one or more actions to automatically resolve the one or more identified diagnostic issues.

14. The method of claim 13, wherein the instructions include a command to download a software update.

15. The method of claim 11, further comprising receiving asynchronous conversations and performing topic structure identification and information extraction to match relevant conversation data to the diagnostic request data.

16. An industrial machine diagnostic system comprising:
a natural language input processing engine;
a software database in communication with the natural language input processing engine;
a machine fleet database in communication with the natural language input processing engine;
a diagnostic database in communication with the natural language input processing engine;
a user profile database in communication with the natural language input processing engine; and
a user device in communication with the natural language input processing engine,
wherein the natural language input processing engine is configured to,
process a natural language input diagnostic request from the user device to extract one or more request data elements,
process information received from the software database, machine fleet database, diagnostic database, and user profile database to extract one or more diagnostic data elements and one or more user profile data elements,
determine a diagnostic recommendation based on analysis of the one or more request data elements, the one or more diagnostic data elements, and the one or more profile data elements, and
output one or more diagnostic recommendations to the user.

17. The industrial machine diagnostic system of claim 16, wherein the natural language input diagnostic request includes audio data, video data, or text data.

18. The industrial machine diagnostic system of claim 16, wherein the natural language input processing engine includes a data search engine, a communication interface, a feed back engine, and a data analysis and recommendation component.

19. The industrial machine diagnostic system of claim 16, wherein the natural language input processing engine is configured to identify one or more diagnostic issues that can be resolved without user engagement and provide instructions to the machine to perform one or more actions to automatically resolve the one or more identified diagnostic issues.

20. The industrial machine diagnostic system of claim 16, wherein the natural language input processing engine includes a natural language processing component configured to identify asynchronous conversations and perform topic structure identification and information extraction to match relevant conversation data to the diagnostic request data.
